(19) United States
(12) Patent Application Publication
(10) Pub. No.: US 2002/0171036 A1
(43) Pub. Date: Nov. 21, 2002

(54) Optical analog potential apparatus

(76) Inventor: Chi Wang Tseng, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/858,608

(22) Filed: May 17, 2001

(51) Int. Cl. G01D 5/34; H01J 1/56

(52) U.S. Cl. 250/229

(57) ABSTRACT

An optical analog potential apparatus comprises a circuit board, an emitter module, a receiver module and a controller. The circuit board has a light emitting assembly; and the emitter module is arranged on the circuit board and has a light guide with a bevel. The receiver module is arranged on the circuit board and has a lens connected to an optoelectronic element. The controller is arranged between the emitter module and the receiver module. The light received by the receiver module is controlled by the controller to provide output of various levels.

### FIELD OF THE INVENTION

The present invention relates to an optical analog potential apparatus especially to an optical analog potential apparatus to prevent abrasion and having long lifetime.

### BACKGROUND OF THE INVENTION

The prior art potential apparatus is used to adjust the volume and tone control of audio set, wherein the brush and carbon film are frequently abraded. Therefore, the lifetime of the potential apparatus is limited and sonic boom is occurred.

### SUMMARY OF THE INVENTION

It is the object of the present invention to provide an optical analog potential apparatus to prevent abrasion and having long lifetime.

To achieve above object, the present invention provides an optical analog potential apparatus comprises a circuit board, an emitter module, a receiver module and a controller. The circuit board has a light emitting assembly; and the emitter module is arranged on the circuit board and has a light guide with a bevel of 45°. The receiver module is arranged on the circuit board and has a convex lens connected to an optoelectronic element. The light emitting assembly can also be a light emitting diode with surface thereof being processed by sand blasting. The controller is arranged between the emitter module and the receiver module and has a driving part connected to a light-blocking part. The optoelectronic element is a phototransistor or a photo diode. The driving part is a projecting plate, a post or an L-shaped plate. The light-blocking part is a T-shaped plate, a hollow barrel with slant bottom or a horizontal plate. The light received by the receiver module is controlled by the controller to provide output of various levels.

The various objects and advantages of the present invention will be more readily understood from the following detailed description when read in conjunction with the appended drawing, in which:

### BRIEF DESCRIPTION OF DRAWING:

FIG. 1 shows the perspective view of the present invention;

FIG. 2 shows the exploded view of the present invention;

FIG. 3 shows the sectional view of the present invention;

FIG. 4 shows the application of the present invention;

FIG. 5 shows the relationship of the voltage generated by the optoelectronic element and the shift of the top cove;

FIG. 6 shows the exploded view of the second preferred embodiment of the present invention;

FIG. 7 shows the exploded view of the second preferred embodiment of the present invention;

FIG. 8 shows the exploded view of the third preferred embodiment of the present invention;

FIG. 9 shows the exploded view of the third preferred embodiment of the present invention; and

FIG. 10 shows the exploded view of the fourth preferred embodiment of the present invention.

### DETAILED DESCRIPTION OF THE INVENTION

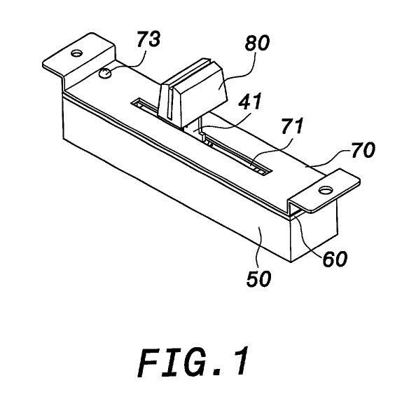

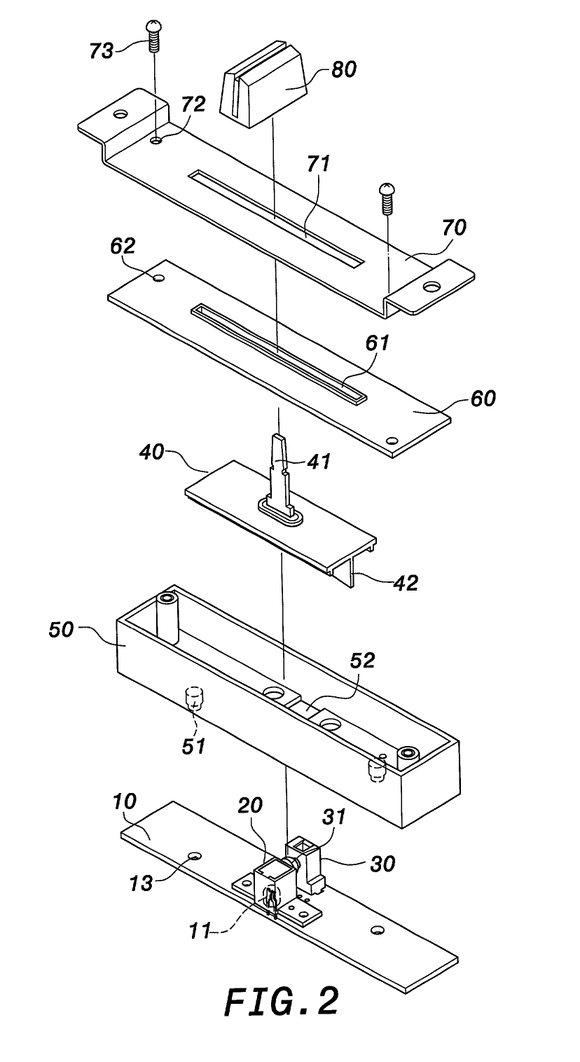

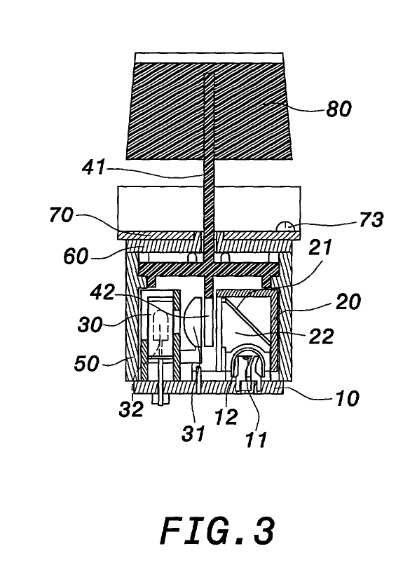

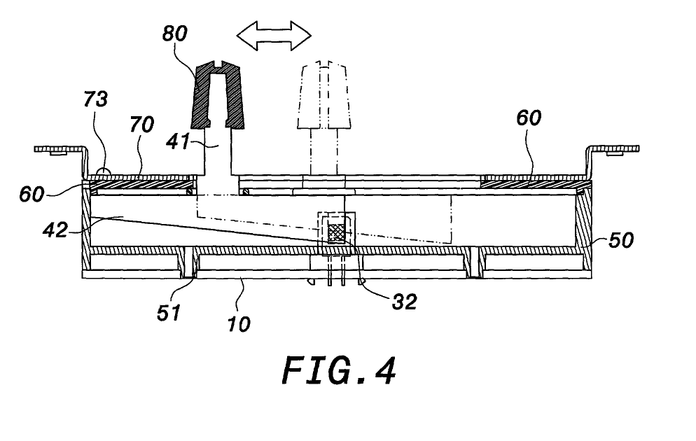

FIGS. 1 to 4 show the first preferred embodiment of the present invention. The optical analog potential apparatus according to the present invention comprises a circuit board 10, an emitter module 20, a receiver module 30 and a controller 40.

The circuit board 10 is mounted with a light emitting assemble composed of a light emitting diode 11 and a concave lens 12 to provide uniform light.

The emitter module 20 is arranged on the circuit board 10 and has a light guide 22 with a 45° bevel 21 arranged atop the light emitting diode 11 and the concave lens 12.

The receiver module 30 is also arranged on the circuit board 10 and has a convex lens 31 and an optoelectronic element 32 such as a phototransistor or a photodiode, which outputs a voltage signal with level controlled by light intensity.

The circuit board 10 has two holes 13 assembled with two bumps 51 on a connection main body 50 such that the circuit board 10 can be assembled to the bottom of the connection main body 50. The emitter module 20 and the receiver module 30 are housed by a hollow portion 52 of the connection main body 50 such that the emitter module 20 and the receiver module 30 are placed within the connection main body 50.

The controller 40 is placed between the emitter module 20 and the receiver module 30 and has a projecting plate 41 connected to a T-shaped plate 42 with slant bottom. The projecting plate 41 is functioned as a driving part and the T-shaped plate 42 is functioned as a light-blocking part. Moreover, the controller 40 has a base plate 60 and a panel 70 attached with the base plate 60. The base plate 60 has a rectangular hole 61 and the panel 70 each has a rectangular hole 71 with similar size. The projecting plate 41 is passed through the rectangular holes 61 and 71. The base plate 60 and the panel 70 have two thread holes 62 and 72 on two lateral sides thereof, two screws 73 are screwed into the thread holes 62 and 72 to fix the connection main body 50. The top portion of the projecting plate 41 is inserted into a top cover 80 and the top cover 80 is slidable along the lengthwise extent of the rectangular holes 61 and 71 such that the controller 40 is also slid laterally.

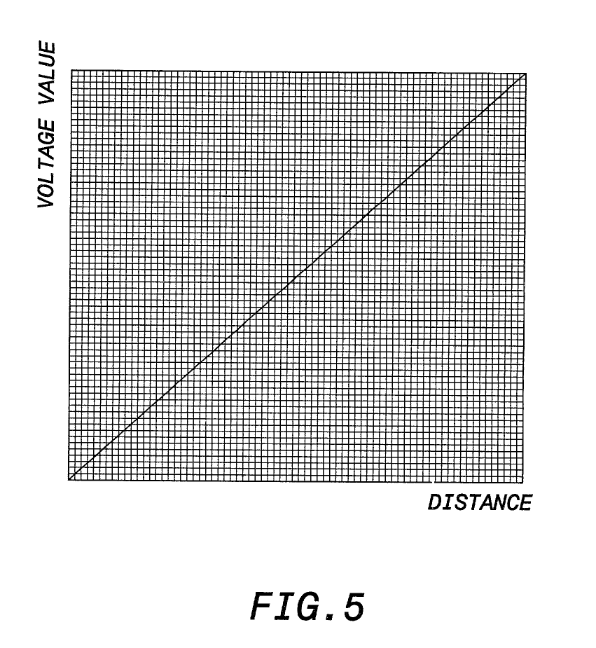

The light from the light emitting diode 11 passes the concave lens 12 to form uniform light. The uniform light is guided by the light guide 22 and reflected by the bevel 21 to form parallel light impinged to the controller 40. When the top cover 80 is placed at leftmost side, the light is completely blocked by the T-shaped plate 42, and no light is transmitted to the receiver module 30. The optoelectronic element 32 detects nothing and does not output a voltage signal with zero level. When the top cover 80 is pushed rightward, the light is partially blocked by the T-shaped plate 42 and the partial light is detected by the optoelectronic element 32 to output a voltage signal with a level corresponding to the detected light. As shown in FIG. 5, the voltage generated by the optoelectronic element 32 is proportional to the rightward shift of the top cover 80. The voltage generated by the optoelectronic element 32 has maximum when the top cover 80 is moved to rightmost position. Therefore, the voltage generated by the optoelectronic element 32 is linearly adjusted by moving the top cover 80.

The optical analog potential apparatus of the present invention can be advantageously used for the control of volume and tone of audio equipments. The potential apparatus is controlled by the optical element; the mechanical fatigue can be prevented.

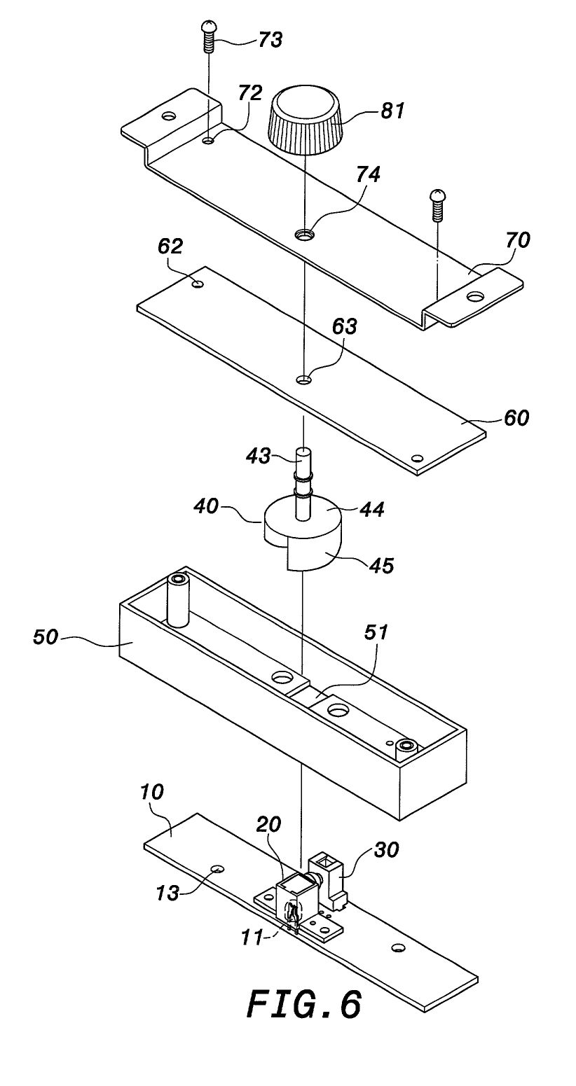

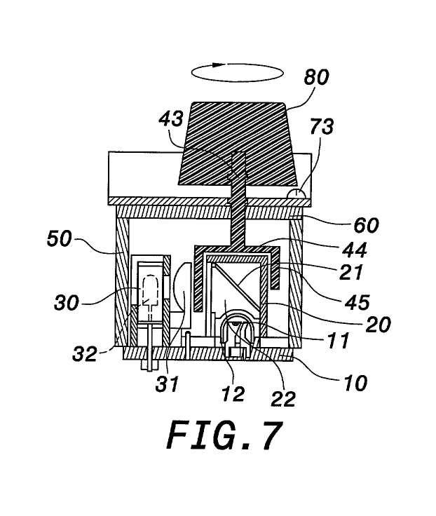

FIGS. 6 and 7 show the second preferred embodiment of the present invention. The emitter module 20 and the receiver module 30 have same structure as those in the first preferred embodiment of the present invention. The controller 40 is placed between the emitter module 20 and the receiver module 30. The controller 40 has a post 43 connected to a hollow barrel 44 with slant bottom. The post 43 is functioned as a driving part and the hollow barrel 44 is functioned as a light-blocking part. The controller 40 has a base plate 60 and a panel 70 attached with the base plate 60.

The base plate 60 and the panel 70 have a rounded hole 63 and 74 at center thereof, respectively. The post 43 is passed through the rounded hole 63 and 74. The base plate 60 and the panel 70 have two thread holes 62 and 72 on two lateral sides thereof, two screws 73 are screwed into the thread holes 62 and 72 to fix the connection main body 50. The top portion of the projecting plate 41 is inserted into a rounded cover 81. The user rotates the rounded cover 81 to rotate the controller 40.

The light from the light emitting diode 11 passes the concave lens 12 to form uniform light. The uniform light is guided by the light guide 22 and reflected by the bevel 21 to form parallel light impinged to the controller 40. When the rounded cover 81 is rotated to the limit of counter clockwise direction, the light is completely blocked by a lateral surface 45 of the hollow barrel 44, and no light is transmitted to the receiver module 30. The optoelectronic element 32 detects nothing and does not output a voltage signal with zero level. When the rounded cover 81 is rotated in clockwise direction, the light is partially blocked by the lateral surface 45 of the hollow barrel 44 and the partial light is detected by the optoelectronic element 32 to output a voltage signal with a level corresponding to the detected light. As shown in FIG. 5, the voltage generated by the optoelectronic element 32 is proportional to the clockwise rotation of the rounded cover 81. The voltage generated by the optoelectronic element 32 has maximum when the rounded cover 81 is moved to limit of clockwise direction. Therefore, the voltage generated by the optoelectronic element 32 is linearly adjusted by moving the rounded cover 81.

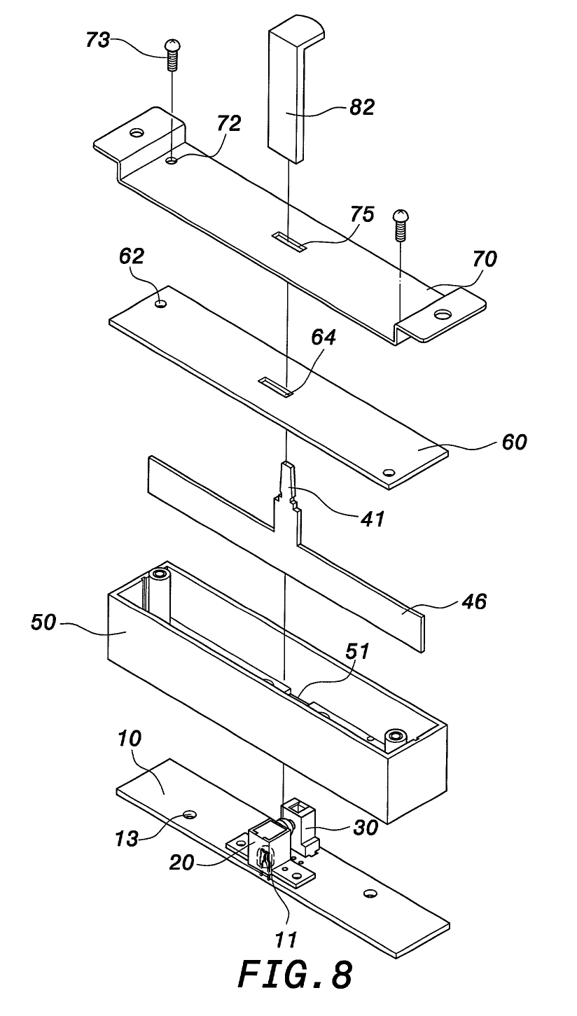

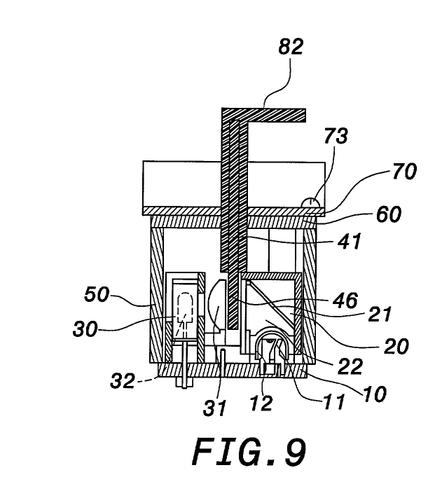

FIGS. 8 and 9 show the third preferred embodiment of the present invention. The emitter module 20 and the receiver module 30 have same structure as those in the first preferred embodiment of the present invention. The controller 40 is placed between the emitter module 20 and the receiver module 30 and has a projecting plate 41 connected to a horizontal plate 46. The projecting plate 41 is functioned as a driving part and the horizontal plate 46 is functioned as a light-blocking part. Moreover, the controller 40 has a base plate 60 and a panel 70 attached with the base plate 60. The base plate 60 has a rectangular hole 64 and the panel 70 each has a rectangular hole 75 with similar size. The projecting plate 41 is passed through the rectangular holes 64 and 75. The base plate 60 and the panel 70 have two thread holes 62 and 72 on two lateral sides thereof, two screws 73 are screwed into the thread holes 62 and 72 to fix the connection main body 50. The top portion of the projecting plate 41 is inserted into a L-shaped plate 82 and the width of the L-shaped plate 82 is smaller than the width of the rectangular holes 64 and 75 such that the L-shaped plate 82 can be moved upward and downward through the rectangular holes 64 and 75 to move upward and downward the controller 40.

The light from the light emitting diode 11 passes the concave lens 12 to form uniform light. The uniform light is guided by the light guide 22 and reflected by the bevel 21 to form parallel light impinged to the controller 40. When the L-shaped plate 82 is pressed downward and the horizontal plate 46 is abutted the circuit board, the light is completely blocked by the horizontal plate 46, and no light is transmitted to the receiver module 30. The optoelectronic element 32 detects nothing and does not output a voltage signal with zero level. When the L-shaped plate 82 is lifted upward, the light is partially blocked by the horizontal plate 46 and the partial light is detected by the optoelectronic element 32 to output a voltage signal with a level corresponding to the detected light. As shown in FIG. 5, the voltage generated by the optoelectronic element 32 is proportional to the upward shift of the L-shaped plate 82. The voltage generated by the optoelectronic element 32 has maximum when the L-shaped plate 82 is moved to up most position. Therefore, the voltage generated by the optoelectronic element 32 is linearly adjusted by moving the L-shaped plate 82.

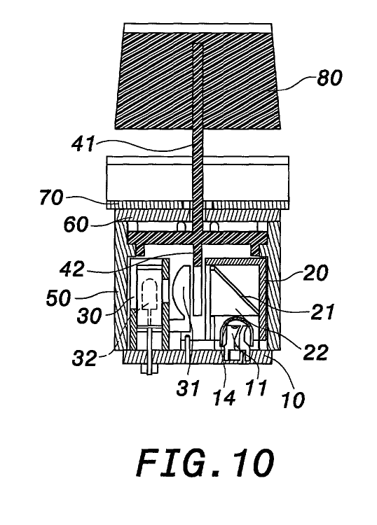

FIG. 10 shows the fourth preferred embodiment of the present invention. The surface of the light emitting diode 11 is treated by sand blasting to have a fuzzy surface 14. The light passed the fuzzy surface 14 also becomes a uniform light. The fuzzy surface 14 can be used to replace the concave lens.

As stated by above description, the present invention performs lateral shift, rotation or upward-downward shift to a cover to provide voltage variation. The optical analog potential apparatus has better durability.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim

1. An optical analog potential apparatus comprising:
a circuit board having a light emitting assembly to provide uniform light;
an emitter module arranged on the circuit board and having a light guide with a bevel and placed atop the light emitting element;
a receiver module arranged on the circuit board and having a lens connected to an optoelectronic element; and
a controller arranged between the emitter module and the receiver module; and having a driving part connected to a light-blocking part;
the light emitting assembly generating a uniform light guided by the light guide; the uniform light reflected by the bevel to form parallel light; the light received by the receiver module being controlled by the controller to provide output of various level.

2. The optical analog potential apparatus as in claim 1, wherein the light emitting assemble is composed of a light emitting diode and a concave lens.

3. The optical analog potential apparatus as in claim 1, wherein the light emitting assembly is a light emitting diode with surface thereof being processed by sand blasting.

4. The optical analog potential apparatus as in claim 1, wherein the bevel has incline angle of 45°.

5. The optical analog potential apparatus as in claim 1, wherein the lens of the receiver module is a convex lens.

6. The optical analog potential apparatus as in claim 1, wherein the optoelectronic element is a phototransistor or a photo diode.

7. The optical analog potential apparatus as in claim 1, wherein the driving part is a projecting plate, a post or an L-shaped plate.

8. The optical analog potential apparatus as in claim 1, wherein the light-blocking part is a T-shaped plate, a hollow barrel with slant bottom or a horizontal plate.
